(19) United States
(12) Patent Application Publication
(10) Pub. No.: US 2012/0026631 A1
(43) Pub. Date: Feb. 2, 2012

(54) PHOTOVOLTAIC ARRAY GROUND FAULT DETECTION IN AN UNGROUNDED SOLAR ELECTRIC POWER GENERATING SYSTEM AND TECHNIQUES TO TRANSITION ONTO AND OFF THE UTILITY GRID

(75) Inventors: HOSSEIN KAZEMI, SAN FRANCISCO, CA (US); VIGGO SELCHAU-HANSEN, DOVER, MA (US)

(73) Assignee: GREENVOLTS, INC, FREMONT, CA (US)

(21) Appl. No.: 13/044,423

(22) Filed: Mar. 9, 2011

Related U.S. Application Data
(60) Provisional application No. 61/424,537, filed on Dec. 17, 2010.
(60) Provisional application No. 61/370,038, filed on Aug. 2, 2010.

(51) Int. Cl. H02H 3/00

(52) U.S. Cl. 361/42

(57) ABSTRACT

In an embodiment, inverter circuitry has switching devices that generate three-phase AC voltage that is supplied to a utility power grid interface transformer. A high impedance circuit as well as a ground fault monitoring circuit couple to the inverter circuit. The high impedance circuit is configured to periodically create a path to Earth ground, and thus, completes the Earth ground electrical path back to the ground fault detection circuit. A set of isolation contacts at the AC 3-phase power output connect as well as isolate this particular inverter from the utility grid interface transformer. Control components in the ground fault monitoring circuit control the operation of the isolation contacts based off a presence of a ground fault in ungrounded solar arrays that supply DC power to this ungrounded inverter circuitry when the ground fault is detected by the ground fault monitor circuit for that ungrounded inverter.

### RELATED APPLICATIONS

This application claims the benefit of and priority to U.S. Provisional Application titled “INTEGRATED ELECTRONICS SYSTEM” filed on Dec. 17, 2010 having application Ser. No. 61/424,537, and U.S. Provisional Application titled “GROUND FAULT MONITORING METHOD FOR UNGROUNDED UTILITY SCALE PHOTOVOLTAIC SYSTEMS” filed on Aug. 2, 2010 having application Ser. No. 61/370,038.

### NOTICE OF COPYRIGHT

A portion of the disclosure of this patent document contains material that is subject to copyright protection. The copyright owner has no objection to the facsimile reproduction by anyone of the interconnect as it appears in the Patent and Trademark Office Patent file or records, but otherwise reserves all copyright rights whatsoever.

### FIELD

In general, a photovoltaic system having a ground fault monitoring circuit in an ungrounded inverter circuit is discussed.

### BACKGROUND

Ground fault detection and controlling a rate at which a utility scale photovoltaic electric system connect to the utility grid are important. In some systems, the residual current monitor at the inverter input cannot detect PV array ground leakage until the inverter is connected to the grid feed, which may result in a safety hazard, equipment damage, or the disconnection of an inverter group by its ground-fault circuit interrupt senses breaker. The latter outcome causes both loss of revenue while the inverter group is off-line, and potentially large maintenance costs to locate the ground fault to a particular PV array.

### SUMMARY

Various methods and apparatus are described for a photovoltaic system. In an embodiment, a high impedance circuit as well as a ground fault monitoring circuit couple to an inverter circuit with switching devices that generate three-phase Alternating Current (AC) voltage supplied to a utility power grid interface transformer. An AC 3-phase power output of the inverter circuitry directly couples to a utility grid interface transformer without connection through an isolation transformer to the utility grid interface transformer. A primary-side common node of the utility power grid interface transformer is not referenced to Earth ground but rather has a connection to the high impedance circuit. The high impedance circuit is configured to periodically create a path to Earth ground, and thus, completes the Earth ground electrical path back for the ground fault detection circuit. Each inverter circuit also has its own set of isolation contacts at the AC 3-phase power output to connect as well as isolate this particular inverter from the utility grid interface transformer. Control components in the ground fault monitoring circuit control the operation of the isolation contacts based off a presence of a ground fault in ungrounded solar arrays that supply Direct Current (DC) power to this ungrounded inverter circuitry when the ground fault is detected by the ground fault monitor circuit for that ungrounded inverter. The inverter circuit receives a DC voltage supplied from its own set of ungrounded Concentrated PhotoVoltaic (CPV) modules. Further, multiple solar arrays, each with their one or more inverter circuits directly couple their three phase AC output to the same utility grid interface transformer.

### BRIEF DESCRIPTION OF THE DRAWINGS

The multiple drawings refer to the embodiments of the invention.

FIG. 1 illustrates a diagram of an embodiment of an ungrounded photovoltaic system having a ground fault monitoring circuit for inverter circuitry with switching devices that generate three-phase Alternating Current (AC) voltage supplied to a utility power grid interface transformer.

FIGS. 2a and 2b illustrate diagrams of an embodiment where an input of each inverter circuit is equipped with a residual current monitor.

FIG. 3 illustrates a diagram of an embodiment of a set of DC batteries coupled to one or more inverter circuits to control a rate of transition of power to and from the utility power grid.

FIG. 4 illustrates a diagram of an embodiment of the ground fault monitoring circuit includes an AC grid current circuit that senses signal processing via isolated and differential sensed to aid in AC ground fault detection.

FIG. 5 illustrates a diagram of an embodiment of a space vector modulated inverter circuit.

FIG. 6 illustrates a diagram of an embodiment of a string of CPV modules and their CPV cells supplying power to an inverter circuit.

FIG. 7 illustrates a diagram of an embodiment of the physical and electrical arrangement of modules in a representative tracker unit.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific voltages, named components, connections, types of circuits, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Further specific numeric references such as a first inverter, may be made. However, the specific numeric reference should not be interpreted as a literal sequential order but rather interpreted that the first inverter is different than a second inverter. Thus, the specific details set forth are merely exemplary. The specific details may be varied from and still be contemplated to be within the spirit and scope of the present invention. The specific details may be varied from and still be contemplated to be within the spirit and scope of the present invention.

In general, various methods and apparatus associated with an impedance circuit as well as a ground fault monitoring circuit for a photovoltaic system are discussed. In an embodiment, inverter circuitry has switching devices that generate three-phase AC voltage that is supplied to a utility power grid interface transformer. The high impedance circuit as well as a ground fault monitoring circuit couple to the inverter circuit. The high impedance circuit is configured to periodically create a path to Earth ground, and thus, completes the Earth ground electrical path back to the ground fault detection circuit. Each inverter circuit also has its own set of isolation contacts at the AC 3-phase power output to connect as well as isolate this particular inverter from the utility grid interface transformer. Control components in the ground fault monitoring circuit control the operation of the isolation contacts based off a presence of a ground fault in ungrounded solar arrays that supply Direct Current (DC) power to this ungrounded inverter circuitry when the ground fault is detected by the ground fault monitor circuit for that ungrounded inverter.

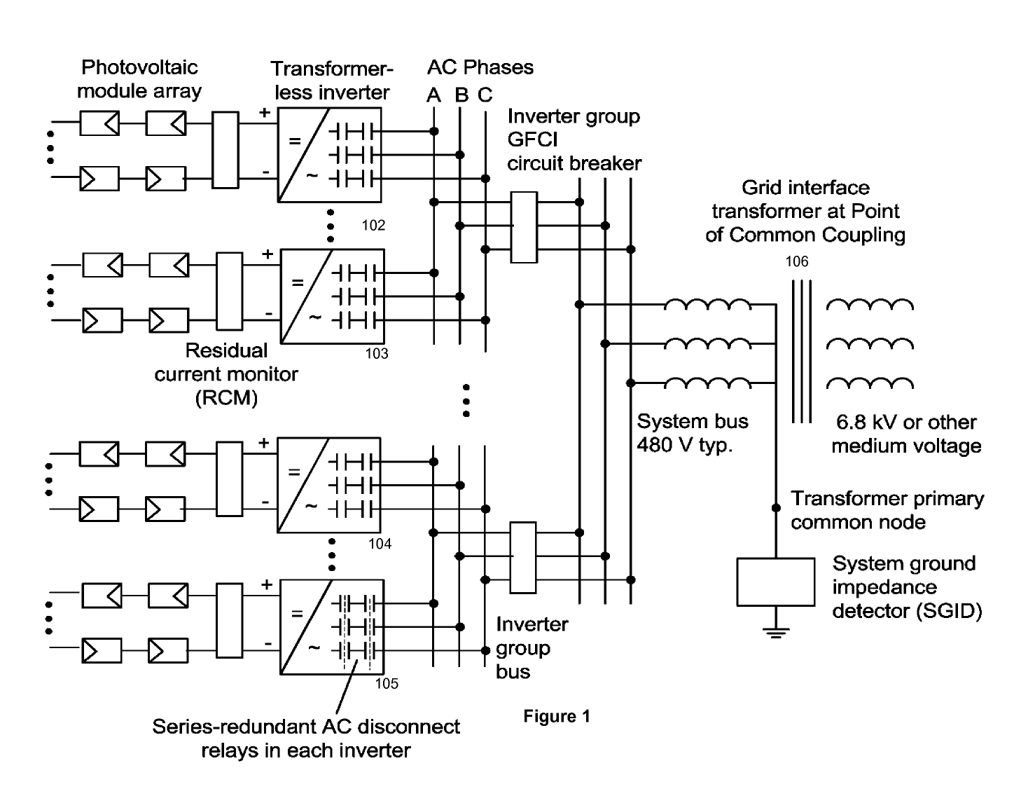

FIG. 1 illustrates a diagram of an embodiment of an ungrounded photovoltaic system having a ground fault monitoring circuit for inverter circuitry with switching devices that generate three-phase Alternating Current (AC) voltage supplied to a utility power grid interface transformer.

A utility-scale photovoltaic (PV) solar electrical power generating system may have a large number of inverters, such as a first through a fourth inverter circuit 102-105, that feed into a common grid-interface transformer 106. The multiple solar arrays, each with their one or more inverter circuits, directly couple their three phase AC output to the same utility grid transformer 106.

Each ungrounded solar array supplies Direct Current (DC) power to its inverter circuit, such as the first inverter circuit 102. Thus, the first inverter circuit 102 receives a DC voltage supplied from its own set of ungrounded Concentrated PhotoVoltaic (CPV) modules.

The ground fault monitoring circuit is configured to detect at least the presence of the ground fault in the ungrounded CPV modules that supply Direct Current (DC) power to the ungrounded inverter circuit.

The input of each inverter is equipped with a residual current monitor (RCM). The residual current monitor senses the unbalanced (“residual”) current condition between the positive and negative leads of the PV module array caused by ground fault current leakage from the solar array, and signals the inverter control components to disconnect the inverter from the grid feed if the residual current level indicates a hazardous condition.

The transformer-less inverter generates the three phase AC output.

In an embodiment, the ground fault monitoring circuit may include the RCM, a separate ground fault measuring circuit with a multiple turn winding, and a system ground impedance detector (SGID).

A high impedance circuit as well as the RCM portion of the ground fault monitoring circuit couple to the inverter circuit with its switching devices that generate three-phase Alternating Current (AC) voltage supplied to a utility power grid interface transformer 106. The AC 3-phase power output of the inverter circuitry directly couples to the utility grid interface transformer 106 without connection through an isolation transformer to the utility grid interface transformer.

A primary-side common node of the Utility Power grid interface transformer 106 is not directly referenced to Earth ground but rather has a connection to the high impedance circuit in the system ground impedance detector, which periodically creates a path to Earth ground, and thus, completes the Earth ground electrical path back for this portion of the ground fault detection circuit when a ground fault occurs in the system. In an embodiment, the neutral leg of the utility transformer 106 connects periodically through an impedance circuit to earth ground. This design may be used in “ungrounded” systems using transformer-less inverters, typically generating 480 V 3-phase power, in which the primary side of the grid interface transformer 106 is not referenced to Earth ground.

Each inverter features series-redundant AC disconnect contactors that disconnect the inverter from the grid feed based on conditions sensed by the inverter controller. The set of isolation contacts at the AC 3-phase power output connect as well as isolate this particular inverter from the utility grid interface transformer. The control components in the ground fault monitoring circuit control the operation of the isolation contacts based off a presence of the ground fault in ungrounded solar arrays that supply DC power to this ungrounded inverter circuitry when the ground fault is detected by the ground fault monitor circuit for that ungrounded inverter.

The isolation contacts and control components of the ground fault monitoring circuit are also configured to prevent the 1) disconnection of the entire solar power generating system or 2) disconnection of an inverter group from the utility power grid interface transformer due to a ground fault occurring in an individual inverter circuit or its associated CPV modules, by a localization of the ground fault to 1) a specific inverter circuit from an inverter group coupling to the utility grid power transformer or 2) even more specifically, a specific set of CPV modules feeding a specific inverter circuit, which also reduce corrective maintenance costs.

A utility-scale photovoltaic (PV) power generating system may have a large number of inverters that feed into a common grid-interface transformer. The multiple solar arrays, each with their one or more inverter circuits, such as two inverters per solar array, directly couple their three phase AC output to the same utility grid interface transformer.

One of the problems that the present design addresses is that, in a conventional ground fault detection scheme, the various detection devices may not be well coordinated, resulting in the disconnection of the entire system or of an inverter group even though the fault may be located in a single inverter or its PV input circuit. In addition, a typical conventional residual current monitor, thus without the additional multiple turn winding at the inverter input, normally cannot detect PV array ground leakage until the inverter is connected to the grid feed, which may result in the system ground impedance detector disconnecting the entire system. These circumstances cause both loss of revenue while the system is off-line, and potentially large maintenance costs to locate the ground fault.

The design prevents the disconnection of the entire solar power generating system or of an inverter group from the grid due to a ground fault occurring in an individual inverter or its associated PV array. Accordingly, each inverter features its own set of series-redundant AC contactors that disconnect this inverter from the grid feed based on conditions sensed by the inverter controller. Further, each inverter circuit in the ungrounded system has its own ground fault monitoring circuit.

As discussed, the system employs various devices to disconnect and/or shut down individual inverters with ground faults for safety reasons or to prevent shut down of the whole solar system. Inverter groups (or less-commonly, individual inverters) are interfaced to a facility bus via ground-fault circuit interrupt (GFCI) breakers. If a ground-fault circuit interrupt breaker senses asymmetrical power flow in the AC phases, it disconnects the inverter group (or single inverter) from the facility grid.

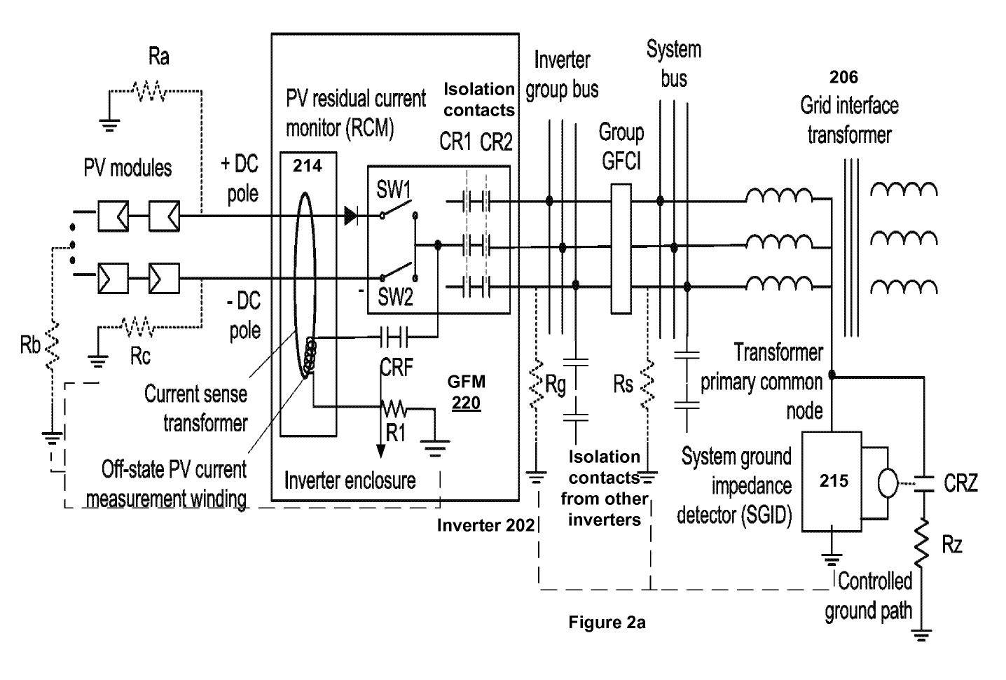

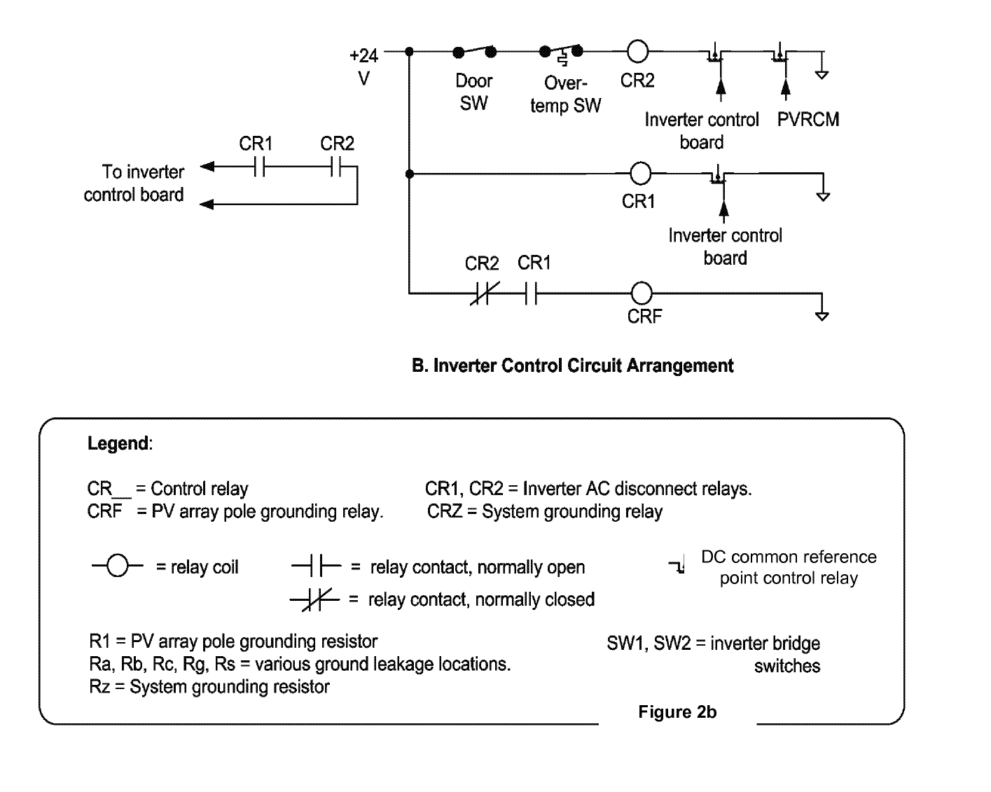

FIGS. 2a and 2b illustrate diagrams of an embodiment where an input of each inverter circuit is equipped with a residual current monitor (RCM). The PV modules that power a given inverter are connected to the inverter circuit 202 as one or more substrings, which are then connected together in series and/or parallel inside the inverter. In these cases, the termination leads of the various substrings of the CPV modules may be routed through the current transformer of the residual current monitor. The leads from the positive and negative poles of the PV array are passed through the core of the current sense transformer of the residual current monitor. The technique adds a second multi-turn current measurement winding to the core that can be connected between one phase of the inverter switching bridge output and a load resistor (R1).

The ground fault monitoring circuit 220 detects the presence of the ground fault via the residual current monitor sensing an unbalanced (“residual”) current condition between the positive and negative leads of the ungrounded CPV modules caused by current leakage from the solar array. The ground fault monitoring circuit 220 then signals the inverter controller to disconnect the inverter by activating the series-redundant AC isolation contacts (i.e. CR1, CR2 isolation contacts) from the Utility Power grid interface transformer 206 when the residual current level indicates a hazardous condition by measuring the unbalanced ground fault current in the CPV modules prior to an operating inverter circuit closing the isolation contacts to supply AC voltage to the utility power grid transformer. This measurement for ground fault current from the solar array prior to powering the inverter prevents disconnecting the entire PV system due to one or more grounded CPV modules merely supplying this inverter circuit. Thus, the ground fault monitoring circuit 220 conducts an Off-state PV solar array leakage resistance measurement prior to connecting the output of the inverter circuit to the Grid.

The ground fault monitoring circuit 220 has a RCM with a multi-turn winding coupled to the core that can be connected between one phase of the inverter switching bridge output and a load resistor, and the residual current monitor is configured to sense an unbalanced (“residual”) current condition between the positive and negative leads of the set of ungrounded CPV modules from the solar array caused by ground fault current leakage from the CPV modules, and then signals the control components in the inverter circuitry to disconnect the output of the inverter circuitry from the utility grid interface transformer 206 feed by opening the isolation contacts when the residual current level is above a threshold level that indicates a hazardous condition.

In non-fault conditions between the ungrounded CPV modules and ungrounded inverter circuit, when in these conditions an electrical open circuit exists at each CPV array pole, and consequently, no current flows even if the CPV solar array is well-illuminated by sunlight because a complete ground path cannot be established in the ground fault loop. However, the ground fault monitoring circuit 220 with the multi-turn current measurement winding connected to the core of the current sense transformer of the residual current monitor creates a path to Earth ground when one or more of the CPV modules has a ground fault then the completes the electrical circuit from the ungrounded CPV modules of the PV solar array back to the multi-turn current measurement winding.

The CPV modules of the PV solar array are ungrounded and the RCM can close contacts to create a path to Earth ground but the complete electrical circuit from the ungrounded positive/negative current generated in the ungrounded photovoltaic array is not completed. Only when ground fault occurs on one of the CPV modules can the complete electrical path be satisfied and thus current flow through the RCM. In an embodiment, the RCM should normally measure roughly zero current or minimal unbalanced current.

In an embodiment, the ground fault monitoring circuit 220 is configured to detect when a ground leak occurs in the CPV modules, when a ground current flows through the path of the CPV modules, the ground fault resistance, one of the conducting switching devices of the inverter circuit, normally open contacts when the inverter circuit is not power on, one lead of the multi-turn current measurement winding, through the other lead of the multi-turn current measurement winding, and a load resister to Earth Ground, and thus completing the Earth ground path between the normally ungrounded CPV modules and normally ungrounded inverter circuit.

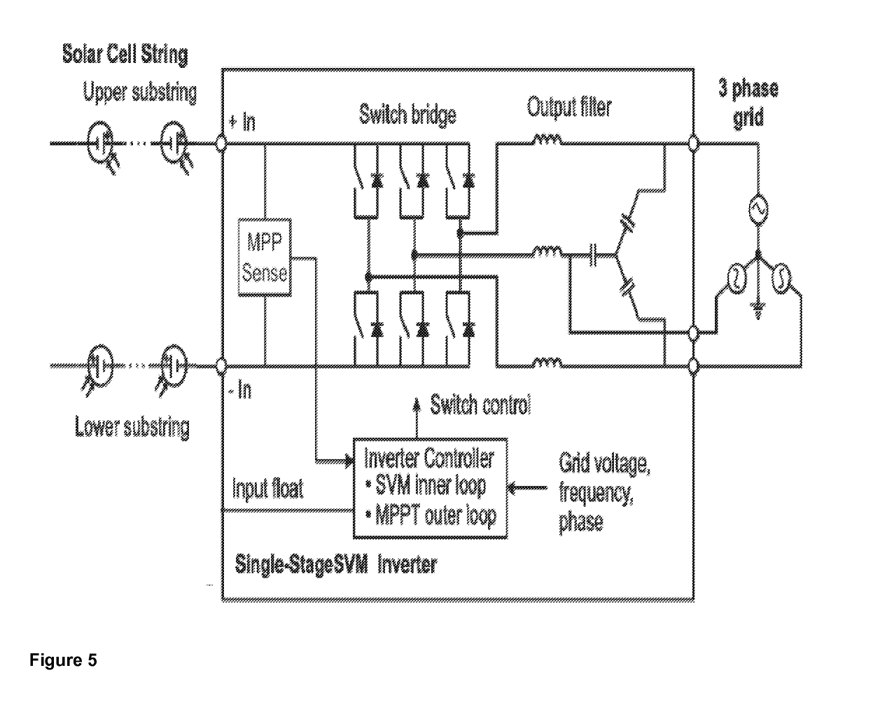

The inverter circuitry with switching devices use Space Vector Modulated bridge switches (see also FIG. 5), nominally generating 480 three phase Volts AC, that directly couple to the utility power grid transformer, without connection through an isolation transformer and then to the utility grid transformer. A neutral wire of the primary side of the utility power grid interface transformer 206 connects to the high impedance circuit.

In some embodiments, to perform this off-state PV solar array ground fault leakage resistance measurement, the inverter logic is powered, but the inverter is not operating to produce a three phase AC output voltage. The PV array is sufficiently illuminated by the Sun so as to produce nominal open-circuit string voltage, Voc. Voc is relatively constant over a range of illumination levels and should be a high voltage value.

Referring to FIG. 2b, the control components in the inverter controller circuit energizes AC disconnect relay CR1, which in turn energizes the off-state PV array leakage measurement relay CRF. Referring to FIG. 2a, the PV array leakage measurement relay contacts, CRF contacts, close and connect the top of the multi-turn winding W1 to one phase of the inverter switching bridge output. Say that this is phase B, which is switched to the positive and negative poles of the PV array during normal inverter operation by bridge switches SW1 and SW2.

With the PV array leakage measurement relay CRF energized, the inverter controller turns on the bridge switching device SW1. This connects the top of the multi-turn winding to the positive pole of the PV array. If the array is free of ground leakage, negligible current flows through the load resistor R1 and the multi-turn winding. However, if there is a ground leakage path on any of the PV modules feeding this inverter, such as Ra, Rb, or Rc, fault current IF1 flows through the multi-turn winding W1 according to the leakage resistance and the number of solar cells between the leak location and positive pole of the PV array. The residual current monitor module outputs a calibrated analog voltage proportional to IF1 that is stored by the inverter controller. Note, when an inverter is connected to the system bus, its PV module array must be floating (ungrounded) to generally prevent a ground loop path between the CPV modules of the solar array and grid interface transformer primary. Nevertheless, the inverter switching action maintains the midpoint of the series-connected PV module array near ground potential.

The inverter controller then next turns off the bridge switching device SW1 and turns on the bridge switching device SW2 to connect the winding to the negative pole of the PV array. The current through the winding, IF2, now depends on the leakage resistance and its location relative to the negative pole. Thus, the location of ground fault can be isolated and determined if coming from the East CPV modules supplying the −600 volts if the detected ground fault current has negative current component and the location of ground fault is determined coming from the West CPV modules supplying the +600 volts if the detected ground fault current has a positive component. The ground fault monitoring circuit localizes of the ground fault to a specific set of CPV modules feeding a specific inverter circuit by when the detected ground fault voltage has a negative voltage component, then the ground fault is coming from the set of CPV modules supplying the negative DC voltage; and likewise, when the detected ground fault voltage has a positive voltage component, then the ground fault is coming from the set of CPV modules supplying the positive DC voltage. As discussed, each inverter circuit may receive a bipolar DC voltage supplied from its own set of CPV modules, where a switching device in the input of the inverter circuit is used to create the common reference point for the positive VDC and the negative VDC inputs from the PV array.

The inverter controller causes one or more of the bridge switching devices to conduct to connect the multiple turns winding to a pole of a string of the CPV modules. The ground fault current through the multiple turn current measuring winding depends on the leakage resistance and its location relative to the pole, and the polarity of the ground fault current indicates when the fault occurs on the East CPV modules supplying the negative voltage or the West modules supplying the positive voltage.

Table 1 gives the example values of fault current IF1 and IF2 in the case where individual solar cell Voc is on the order of 3 Vdc.

TABLE 1
PV Array Leakage Current Magnitudes

| | ground | ground | ground |
|---|---|---|---|
| Fault Location | leakage path Ra | leakage path Rb* | leakage path Rc |
| SW1 | I_{F1} ≈ 0 | I_{F1} ≈ 3n/ | I_{F1} ≈ 1200/ |
| closed | | (R1 + Rb) | (R1 + Rc) |
| SW2 | I_{F2} ≈ −1200/ | I_{F2} ≈ −3m/ | I_{F2} ≈ 0 |
| closed | (R1 + Ra) | (R1 + Rb) | |

Fault location ground leakage path Rb, the general case, is separated from the positive pole by n solar cells and from the negative pole by m solar cells.

For example, if the array Voc is 1200 Vdc and load resistor R1 is 10 kilo ohms:
For ground leakage path Rb=500 kilo ohms and located at the center of the string, I_{F1}=−I_{F2}≈ 600/510,000=1.2 mA.
For ground leakage path Ra=500 kilo ohms. I_{F1}≈0, and I_{F2}≈− 1200/510,000=−2.4 mA.
For ground leakage path Ra=0. I_{F1}≈0, and I_{F2}≈− 1200/10,000=±120 mA.

The current sensed by the residual current monitor is the algebraic sum of the currents coupled to the current sense transformer, and the calculation of IF must account for the turns count of the multi-turn winding and its sense with respect to the positive and negative PV string leads coupled to the transformer. If the winding has N turns, the coupled current is IF (N+1) or IF (N−1) according to the winding direction.

Given measurements of IF1 and IF2 obtained as above, the inverter controller logic can calculate the ground leakage resistance according to the following system of simultaneous equations, where ground leakage path Rb is the general case, and string Voc is known (estimated or separately measured by the inverter controller).

IF1=Vn/(R1+Rb)

IF2=−Vm/(R1+Rb)

Vn+Vm=String Voc

The method detects electrical shorts or low resistance faults between various points of the PV string, and these are separately detectable by the inverter as abnormally low string Voc.

Referring to FIG. 2a, if the inverter controller determines that current in the ground leakage path Rb is not greater than predetermined limit RbLIMIT, it energizes CR2, which de-energizes the PV array leakage measurement relay CRF and connects the inverter output to the 480 V bus and allows the inverter to operate. Otherwise, if the current in the ground leakage path Rb is greater than predetermined limit RbLIMIT, the array ground leak constitutes a ground fault and the inverter remains off-line.

The system ground impedance detector may use active system grounding to induce selective inverter disconnection in this ungrounded system. The system ground impedance detector is augmented with system grounding resistor (Rz) and associated system grounding control relay (CRZ). Referring to FIG. 2b, each inverter circuit that passed the above off-state PV array leakage resistance measurement is now operating, producing three phase AC power, and is connected to the grid feed. With the PV array leakage measurement relay CRF de-energized, the multi-turn winding is inactive and the residual current monitor operates as a standard residual current monitor.

In an embodiment, the high impedance circuit is in the system ground impedance detector (SGID) and is connected between the transformer's primary common node and Earth ground. The high impedance circuit periodically creates a path to Earth ground and thus completes the earth ground electrical path back to the ground fault detection circuit by periodically closing a relay contact to make a path to Earth ground for the grid interface transformer 206 primary common node through a high resistance system grounding resistor Rz and the relay contact according the following rationale. When high impedance circuit creates an Earth ground path to the PV solar array with a ground fault condition similar to earlier approach, then when leakage current detected, then a signal is sent to a controller circuit and the controller circuit causes isolation contacts CR1 and CR2 for that inverter to open.

The high impedance circuit in the system ground impedance detector monitors system impedance to Earth ground and signals the ground fault monitor circuit to open the isolation contacts to disconnect from the utility power grid interface transformer 206 when the impedance level indicates a ground fault. Because the inverters are transformer-less, the system ground impedance detector is responsive to ground leakage conditions at the various photovoltaic modules.

All of the aforementioned ground fault monitor devices in the system (residual current monitors, ground-fault circuit interrupt senses breakers, system ground impedance detector) are now active and operate, except that the system ground impedance detector is augmented with the means to ground the grid interface transformer 206 primary common node via the system grounding resistor Rz. The relative sensitivities and response times of the residual current monitors, ground-fault circuit interrupt senses breakers and system ground impedance detector may be coordinated.

The SGID 215 is response to excessive PV array ground leakage. Referring to FIG. 2a, let ground leakage path Rb represent the general case of a ground leak developing at some point along a PV array, including at a pole. Ideally, the associated residual current monitor would disconnect the inverter if ground leakage path Rb is less that the regulatory safety limit RbLIMIT, regardless of the leak location. However, the residual current caused by ground leakage path Rb dependents on its location: Since the potential of the PV string midpoint is balanced around ground, a given value of ground leakage path Rb occurring at the midpoint results in less leakage current, and hence lower residual current at the residual current monitor, than the same value of ground leakage path Rb occurring nearer the positive or negative string pole.

However, the effect of ground leakage path Rb on the system ground impedance measured by the system ground impedance detector is dominated by the value of ground leakage path Rb and not its location. Therefore, the system ground impedance detector is set to engage the system grounding resistor Rz when the sensed impedance is indicative of Rb<RbLIMIT. With the system grounding resistor Rz engaged, a ground loop current is induced through ground leakage path Rb and the residual current monitor that depends jointly on ground leakage path Rb and the system grounding resistor Rz. The value of the system grounding resistor Rz is selected such that the residual current in the residual current monitor due to Rb<RbLIMIT exceeds the residual current monitor trip-point. The system ground impedance detector engages the system grounding resistor Rz for a time period that exceeds the group ground-fault circuit interrupt senses breaker response time, which is longer than the residual current monitor response time.

Given this coordination of system ground impedance detector threshold, the system grounding resistor Rz value, and the system grounding resistor hold-in time with the residual current monitor threshold and response time, the active system grounding invoked by the system ground impedance detector causes the residual current monitor to trip and take the inverter off-line before the system grounding resistor Rz is released (for Rb near the PV array poles, the residual current monitor would have tripped anyway). This action does not affect the other inverters having ground leakage path Rb>RbLIMIT. Upon releasing the system grounding resistor Rz, the system ground impedance detector senses normal ground impedance and keeps the remainder of the system on-line.

These actions do not trip the ground-fault circuit interrupt senses breaker to which the inverter is connected because PV array ground leakage affects the three AC phases symmetrically, resulting in negligible residual current between the phases.

The SGID 215 may also respond to ground leakage from an inverter group bus phase. Referring to FIG. 2a, Rg represents a ground leak from an AC phase upstream of a group ground-fault circuit interrupt senses breaker, either in an inverter or on the group bus. The system ground impedance detector senses ground leakage path Rg and engages the system grounding resistor Rz if Rg is less than the Rb-related threshold described above. The electrical circuit is completed between the Earth ground of the SGID 215 and the Earth ground of the ground leakage path Rg. A ground current loop is induced in the affected phase through the ground leakage path Rg and the ground-fault circuit interrupt senses breaker that depends jointly on the ground leakage path Rg and the system grounding resistor Rz. If the resulting phase-to-phase current imbalance and duration exceeds the ground-fault circuit interrupt senses breaker trip point, the ground-fault circuit interrupt senses breaker disconnects the inverter group. Upon releasing the system grounding resistor Rz, the system ground impedance detector senses normal ground impedance and keeps the remainder of the system on-line.

The SGID 215 may also respond to ground leakage from the system bus. Referring to FIG. 2a, Rs represents a ground leak from an AC phase of the system bus. The system ground impedance detector senses Rs and engages the system grounding resistor Rz if Rs is less than the Rb-related threshold described above. This action will have no affect on the residual current monitors or ground-fault circuit interrupt senses breakers. Upon releasing the system grounding resistor Rz, the system ground impedance detector continues to sense Rg. If Rg is less than a pre-established limit, the system ground impedance detector signals the entire system to disconnect from the grid according to conventional protocols.

Compared with the conventional ground fault response systems, the design prevents the disconnection of the entire solar power generating system or of an inverter group from the grid due to a ground fault occurring in an individual inverter or its associated PV array. This maximizes system revenue. Also, localization of the fault to a specific inverter or inverter group also reduces corrective maintenance costs.

In some system configurations, the PV modules that power a given inverter are connected to the inverter as one or more substrings, which are then connected together in series and/or parallel inside the inverter. In these cases, the termination leads of the various substrings may be routed through the PV residual current monitor current transformer if analysis determines that this improves or does not degrade fault detection sensitivity.

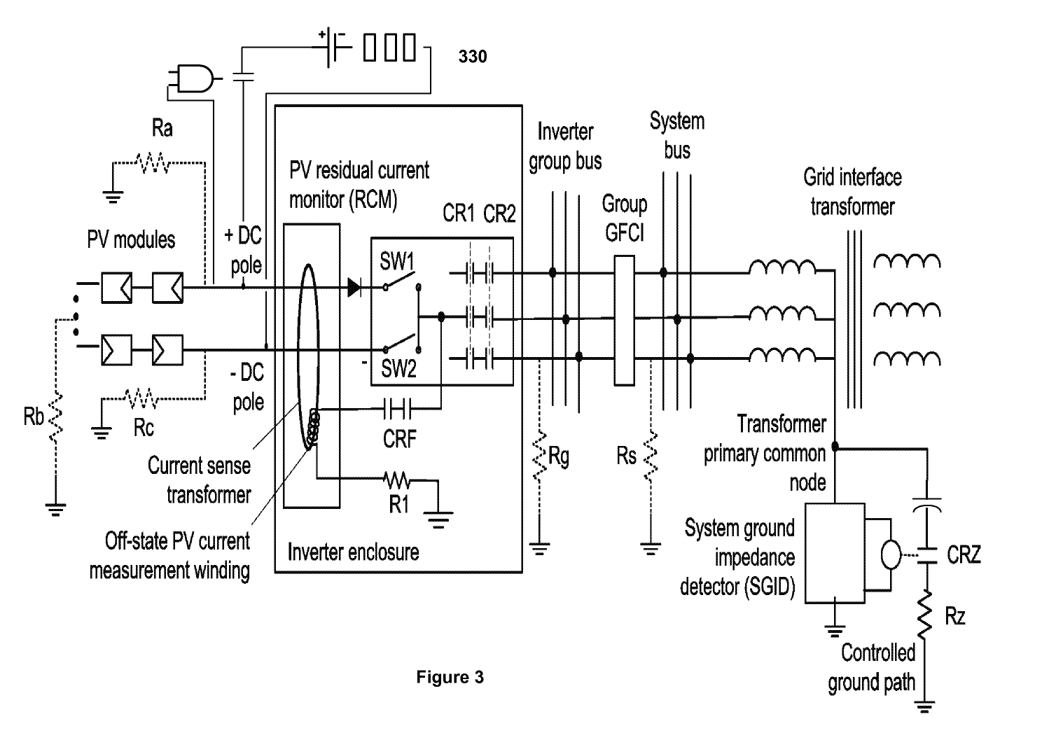

FIG. 3 illustrates a diagram of an embodiment of a set of DC batteries coupled to one or more inverter circuits to control a rate of transition of power to and from the utility power grid. The photovoltaic power generating station may have a set of long life high capacity DC batteries 330 on-site and charged by the solar arrays. The set of high capacity DC batteries 330 on-site couple to for example multiple inverter circuits to control a rate of transition of power from the utility power grid when one or more of the inverter circuits abruptly stop providing AC power. The solar arrays charge this set of long life high capacity DC batteries 330 and the set of DC batteries 330 reconnect back into an input of the inverter circuit that couples to the utility power grid. A power sensing circuit feeds of the DC input voltage to each inverter. A comparator circuit determines if the DC voltage falls below a certain threshold and the control relay is asserted to indicate that the inverter should be producing output AC voltage, then the DC batteries 330 contacts close to replace or augment the DC voltage feed from the PV arrays. The fully charged set of DC batteries 330 control the rate that the photovoltaic generation facility stops providing power to the utility power grid. The inverters will produce a gradual decrease in the AC power produced or if the duration of the loss of voltage from the PV array is just a short term passing cloud then the capacity of the batteries 330 is set such that the transition in output AC power is de minimis. Also, a connection algorithm in the inverter controller controls a rate that the photovoltaic generation facility starts providing power to the utility power grid. These two factors allow the transition of power to and from the utility power grid to minimize abrupt transitions of significant power capacity to the utility grid.

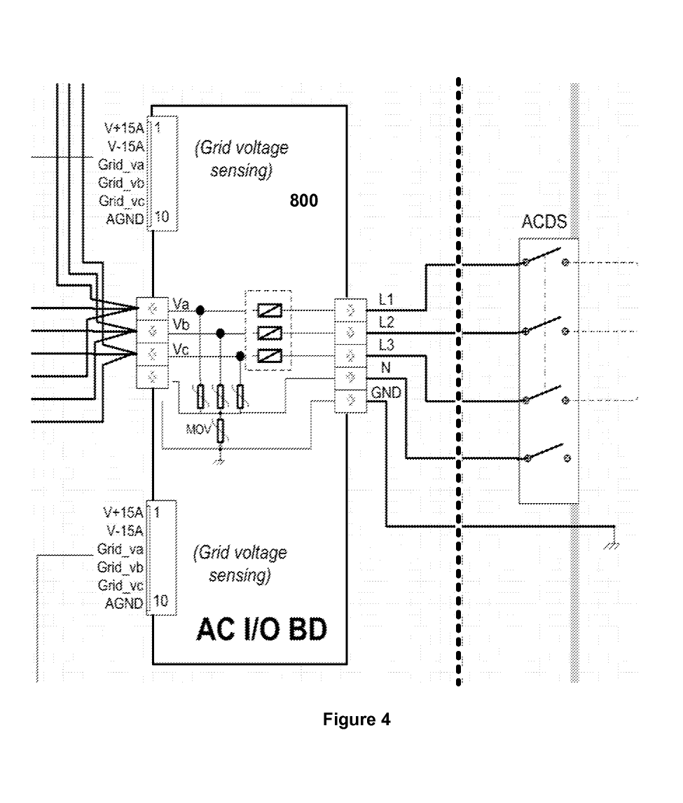

FIG. 4 illustrates a diagram of an embodiment of the ground fault monitoring circuit includes an AC grid current circuit that senses signal processing via isolated and differential sensed to aid in AC ground fault detection. The AC Grid Current circuit 800 provides ground fault detection for connection onto the National Power grid side of the inverters that supply three phase AC electrical power.

The AC Grid Current circuit 800 is configured to sense signal processing via a differential sense circuit. The signal processing may be via a 50 KHz LPF, differentially sensed circuit.

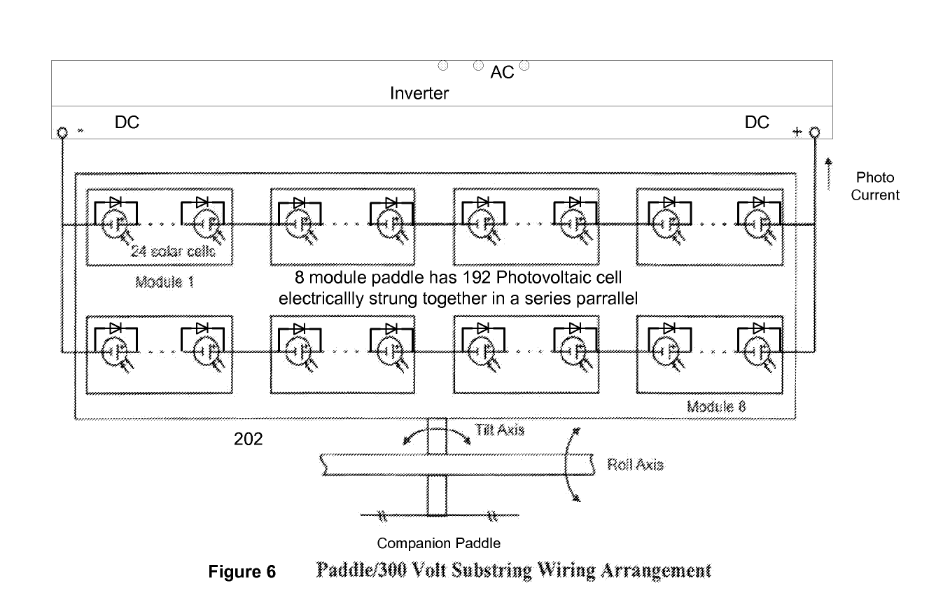

FIG. 6 illustrates a diagram of an embodiment of a string of CPV modules and their CPV cells supplying power to an inverter circuit. The most economical and reliable means of converting the DC output of a series-wired string of solar cells 202 is to operate the string into a single-stage DC-AC inverter. However, a string of CPV modules 202 that conforms to the safety code for maximum voltage may not provide sufficient voltage for single-stage inversion to AC grid power. In some embodiments, this technique allows the use of longer, higher-voltage strings without violating safety requirements so that single-stage inversion can be used with a wider variety of solar cells and AC grid voltages.

Briefly, in order to obtain the maximum power converter input voltage within safety limits, a series-string of solar cells can be grounded at its midpoint so that no point of the string exceeds +/−600 Vdc (US) or +/−1000 Vdc (EU) with respect to utility ground. This creates a bipolar string 202.

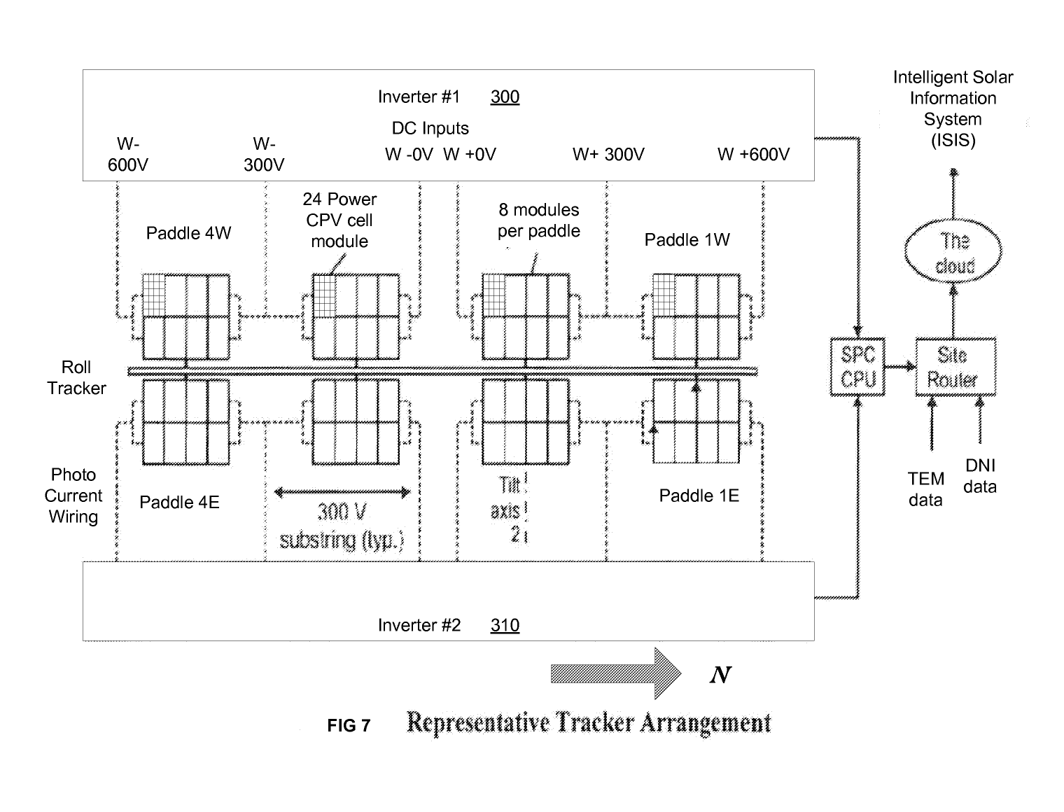

FIG. 7 illustrates a diagram of an embodiment of the physical and electrical arrangement of modules in a representative tracker unit. Here, there are 24 power units per module, eight modules per paddle, two paddles per tilt axis, and four independently-controlled tilt axes per common roll axis. As discussed, the bi-polar voltage from the set of paddles may be, for example, a +600 VDC and a −600 VDC making a 1200 VDC output coming from the 16 PV modules. The 16 PV module array may be a string/row of PV cells arranged in an electrically series arrangement of two 300 VDC panels adding together to make the +600 VDC, along with two 300 VDC panels adding together to make the −600 VDC. These voltages are supplied to the inverters 300, 310.

Although the foregoing embodiments have been described in some detail for purposes of clarity of understanding, the invention is not limited to the details provided. The Solar array may be organized into one or more paddle pairs. CPV modules on the West side and East side may supply different amounts of voltage or current. Functionality of circuit blocks may be implemented in hardware logic, active components including capacitors and inductors, resistors, and other similar electrical components. There are many alternative ways of implementing the invention. The disclosed embodiments are illustrative and not restrictive.

We claim:

1. An apparatus for a photovoltaic system, comprising:
a high impedance circuit as well as a ground fault monitoring circuit for an inverter circuit with switching devices that generate three-phase Alternating Current (AC) voltage supplied to a utility power grid interface transformer,
where an AC 3-phase power output of the inverter circuitry directly couples to a utility grid interface transformer without connection through an isolation transformer to the utility grid interface transformer,
where a primary-side common node of the Utility Power grid interface transformer is not referenced to Earth ground but rather has a connection to the high impedance circuit, which periodically creates a path to Earth ground, and thus, completes the Earth ground electrical path back for the ground fault detection circuit,
where each inverter circuit also has its own set of isolation contacts at the AC 3-phase power output to connect as well as isolate this particular inverter from the utility grid interface transformer,
where control components in the ground fault monitoring circuit control the operation of the isolation contacts based off a presence of a ground fault in ungrounded solar arrays that supply Direct Current (DC) power to this ungrounded inverter circuitry, when the ground fault is detected by the ground fault monitor circuit for that ungrounded inverter, and
where the inverter circuit receives a DC voltage supplied from its own set of ungrounded Concentrated PhotoVoltaic (CPV) modules, and where multiple solar arrays, each with their one or more inverter circuits directly couple their three phase AC output to the same utility grid interface transformer.

2. The apparatus for a photovoltaic system of claim 1, where the ground fault monitoring circuit has a residual current monitor (RCM) with a multi-turn winding coupled to the core that can be connected between one phase of the inverter switching bridge output and a load resistor, and the residual current monitor is configured to sense an unbalanced current condition between the positive and negative leads of the set of ungrounded CPV modules from the solar array caused by ground fault current leakage from the CPV modules, and then signals the control components in the inverter circuitry to disconnect the output of the inverter circuitry from the utility grid interface transformer feed by opening the isolation contacts when the residual current level is above a threshold level that indicates a hazardous condition.

3. The apparatus for a photovoltaic system of claim 1, where the ground fault monitoring circuit is configured to detect the presence of the ground fault in the ungrounded CPV modules that supply Direct Current (DC) power to the ungrounded inverter circuit, where the inverter circuitry with switching devices use Space Vector Modulated bridge switches, generating three phase Volts AC, and where the termination leads of the CPV modules are routed through the current transformer of the residual current monitor.

4. The apparatus for a photovoltaic system of claim 1, where each inverter circuit in the ungrounded system has its own ground fault monitoring circuit, where an input of each inverter circuit is equipped with a residual current monitor (RCM), and where the ground fault monitoring circuit detects the presence of the ground fault via the residual current monitor sensing an unbalanced residual current condition between the positive and negative leads of the ungrounded CPV modules caused by current leakage from the solar array, and signals the inverter controller to disconnect the inverter by activating the series-redundant AC isolation contacts from the Utility Power grid interface transformer when the residual current level indicates a hazardous condition by measuring the above unbalanced current ground fault in the CPV modules prior to an operating inverter circuit closing the isolation contacts to supply AC voltage to the utility power grid transformer, which prevents disconnecting the entire PV system due to the grounded CPV module from merely supplying this inverter circuit.

5. The apparatus for a photovoltaic system of claim 1, where in non-fault conditions between the ungrounded CPV modules and ungrounded inverter circuit, when in these conditions an electrical open circuit exists at each CPV array pole, and consequently, no current flows even if the CPV solar array is well-illuminated by sunlight because a complete ground path cannot be established in the ground fault loop, however the ground fault monitoring circuit but a multi-turn current measurement winding connected to the core of the current sense transformer of the residual current monitor creates a path to Earth ground and when one or more of the CPV modules has a ground fault then the complete electrical circuit from the ungrounded CPV modules of the PV solar array back to the multi-turn current measurement winding is completed.

6. The apparatus for a photovoltaic system of claim 1, where the ground fault monitoring circuit is configured to detect when a ground leak occurs in the CPV modules, when a ground current flows through the CPV modules, ground fault resistance, one of the conducting switching devices of the inverter circuit, normally open contacts when the inverter circuit is not power on, one lead of the multi-turn current measurement winding, through the other lead of the multi-turn current measurement winding, and a load resister to Earth ground, and thus completing the Earth ground path between the normally ungrounded CPV modules and normally ungrounded inverter circuit.

7. The apparatus for a photovoltaic system of claim 1, where the high impedance circuit in the system ground impedance detector (SGID) is connected between the transformer's primary common node and Earth ground, which monitors system impedance to Earth ground and signals the ground fault monitor circuit to open the isolation contacts to disconnect from the utility power grid interface transformer when the impedance level indicates a ground fault.

8. The apparatus for a photovoltaic system of claim 1, where the high impedance circuit is in the SGID is connected between the transformer's primary common node and Earth ground, and the high impedance circuit periodically creates a path to Earth ground and thus completes the earth ground electrical path back to the ground fault detection circuit by periodically closing a relay contact to make a path to Earth ground for the grid interface transformer primary common node through a high resistance system grounding resistor and the relay contact, and when the high impedance circuit creates ground path to the CPV modules, then signal the control components to cause the isolation contacts for that inverter to open.

9. The apparatus for a photovoltaic system of claim 1, where each inverter circuit receives a bipolar DC voltage supplied from its own set of CPV modules, where a switching device in the input of the inverter circuit is used to create the common reference point for the positive VDC and the negative VDC inputs from the PV array, and
where the ground fault monitoring circuit localizes of the ground fault to a specific set of CPV modules feeding a specific inverter circuit by when the detected ground fault voltage has a negative voltage component, then the ground fault is coming from the set of CPV modules supplying the negative DC voltage; and likewise, when the detected ground fault voltage has a positive voltage component, then the ground fault is coming from the set of CPV modules supplying the positive DC voltage.

10. The apparatus for a photovoltaic system of claim 1, where the inverter controller causes one or more of the bridge switching devices to conduct to connect the winding to a pole of a string of the CPV modules, and the ground fault current through the multiple turn current measuring winding depends on the leakage resistance and its location relative to the pole, and the polarity of the ground fault current indicates when the fault occurs on the East CPV modules supplying the negative voltage or the West modules supplying the positive voltage.

11. The apparatus for a photovoltaic system of claim 1, where multiple solar arrays, each with their one or more inverter circuits, directly couple their three phase AC output to the same utility power grid interface transformer, and where the isolation contacts and control components of the ground fault monitoring circuit are configured to prevent the 1) disconnection of the entire solar power generating system or 2) disconnection of an inverter group from the utility power grid interface transformer due to a ground fault occurring in an individual inverter circuit or its associated CPV modules, by a localization of the ground fault to 1) a specific inverter circuit from an inverter group coupling to the utility grid power transformer or 2) even more specifically, a specific set of CPV modules feeding a specific inverter circuit, which also reduce corrective maintenance costs.

12. The apparatus for a photovoltaic system of claim 1, further comprising:
a set of high capacity DC batteries on-site couple to one or more of the inverter circuits to control a rate of transition of power from the utility power grid when the inverter circuits abruptly stop providing AC power.

13. The apparatus for a photovoltaic system of claim 1, where the solar arrays also charge a set of long life high capacity DC batteries on-site and the set of DC batteries reconnect back into an input of the inverter circuit that couples to the utility power grid, where the fully charged set of DC batteries control the rate that the photovoltaic generation facility stops providing power to the utility power grid, and a connection algorithm in the inverter controller controls a rate that the photovoltaic generation facility starts providing power to the utility power grid, and where these two factors allow the transition of power to and from the utility power grid to minimize abrupt transitions of significant power capacity to the utility grid.

14. The apparatus for a photovoltaic system of claim 1, where the ground fault monitoring circuit includes an AC Grid Current circuit that senses signal processing via isolated and differential sensed to aid in AC ground fault detection.

15. A method for a photovoltaic system, comprising:
coupling a high impedance circuit as well as a ground fault monitoring circuit to an inverter circuit with switching devices that generate three-phase Alternating Current (AC) voltage supplied to a utility power grid interface transformer,
coupling an AC 3-phase power output of the inverter circuitry directly to a utility grid interface transformer without connection through an isolation transformer to the utility grid interface transformer,
coupling a primary-side common node of the Utility Power grid interface transformer not directly to Earth ground but rather has a connection to the high impedance circuit,
configuring the high impedance circuit to periodically create a path to Earth ground, and thus, completes the Earth ground electrical path back to the ground fault detection circuit,
configuring each inverter circuit to have its own set of isolation contacts at the AC 3-phase power output, which connect as well as isolate this particular inverter from the utility grid interface transformer, and
configuring control components in the ground fault monitoring circuit to control the operation of the isolation contacts based off a presence of a ground fault in ungrounded solar arrays that supply Direct Current (DC) power to this ungrounded inverter circuitry, when the ground fault is detected by the ground fault monitor circuit for that ungrounded inverter.
